(19) United States
(12) Patent Application Publication
(10) Pub. No.: US 2020/0011356 A1
(43) Pub. Date: Jan. 9, 2020

(54) HYDRAULIC PUMP WITH SECONDARY SAFETY CHECK VALVE

(71) Applicant: Snap-on Incorporated, Kenosha, WI (US)

(72) Inventors: Benjamin T. Schulz, Oak Creek, WI (US); Jonathan I. Andersen, Racine, WI (US); Daniel Eggert, Kenosha, WI (US)

(73) Assignee: Snap-on Incorporated, Kenosha, WI (US)

(21) Appl. No.: 16/030,279

(22) Filed: Jul. 9, 2018

(51) Int. Cl. F15B 20/00; F15B 15/18

(52) U.S. Cl. CPC F15B 20/008; F15B 15/202; F15B 15/18

(57) ABSTRACT

A hydraulic power unit for a floor jack that includes a secondary safety check valve (SSCV) to provide additional leakdown protection, backing up the main check valve. The SSCV acts as a safety measure to prevent the unit from losing load bearing capabilities if the main check valve fails. In addition, the SSCV acts as a means to prevent debris from entering the main check valve, thereby reducing the chance for failure due to an obstruction.

### TECHNICAL FIELD OF THE INVENTION

The present application relates generally to floor jacks. More particularly, the present invention relates to hydraulic pumps for floor jacks with secondary safety check valves.

### BACKGROUND OF THE INVENTION

Floor jacks are used in repair shops to lift a vehicle from the ground. An operator positions the floor jack underneath a lift point and raises the vehicle at that point. Floor jacks can be powered by manual or automated means, and have become important to the automotive repair industry.

Several tons of hydraulic pressure can be generated within the hydraulic power units of floor jacks. Pressure leaks reduce the efficiency of the power units, and can lead to the jack failing. The power units include a main check valve between the hydraulic pump and lifting piston. When fluid is pumped, the main check valve opens, transferring the pressurized fluid into the cylinder containing the lifting piston. The main check valve is then supposed to close, preventing the pressurized fluid from leaking back out of the lift cylinder. However, there are no current solutions to address leaks through the main check valve, or the check valve failing, which can cause catastrophic failure, leading to property damage and/or personal injury or death.

### SUMMARY OF THE INVENTION

The present invention relates broadly to a hydraulic power unit for the floor jack that includes a secondary safety check valve (SSCV) to provide additional leakdown protection, backing up the main check valve. The SSCV utilizes a check ball valve. By using a check ball valve, the SSCV also acts as a safety measure to prevent the unit from losing load bearing capabilities if the main check valve fails. In addition, the SSCV acts as a means to prevent debris from entering the main check valve, thereby reducing the chance for failure due to an obstruction.

### BRIEF DESCRIPTION OF THE DRAWINGS

For the purpose of facilitating an understanding of the subject matter sought to be protected, there is illustrated in the accompanying drawing embodiments thereof, from an inspection of which, when considered in connection with the following description, the subject matter sought to be protected, its construction and operation, and many of its advantages, should be readily understood and appreciated.

FIG. 1 is an assembled view of a typical floor jack incorporating an embodiment of the present invention.

FIG. 2 is a disassembled, exploded perspective view of the jack of FIG. 1.

FIG. 3 is a top view of the power unit according to an embodiment of the present invention.

FIG. 4 is a cross-sectional view of the power unit along the line 4-4′ in FIG. 3.

FIG. 5 is a cross-sectional view of the power unit along the line 5-5′ in FIG. 3.

### DETAILED DESCRIPTION

While the present invention is susceptible of embodiments in many different forms, there is shown in the drawings, and will herein be described in detail, a preferred embodiment of the invention with the understanding that the present disclosure is to be considered as an exemplification of the principles of the invention and is not intended to limit the broad aspect of the invention to embodiments illustrated. As used herein, the term “present invention” is not intended to limit the scope of the claimed invention and is instead a term used to discuss exemplary embodiments of the invention for explanatory purposes only.

The present invention relates broadly to a hydraulic power unit for a floor jack that includes a secondary safety check valve (SSCV) to provide additional leakdown protection, backing up the main check valve. The SSCV utilizes a check ball valve. By using a check ball valve, the SSCV also acts as a safety measure to prevent the unit from losing load bearing capabilities if the main check valve fails. In addition, the SSCV acts as a means to prevent debris from entering the main check valve, thereby reducing the chance for failure due to an obstruction.

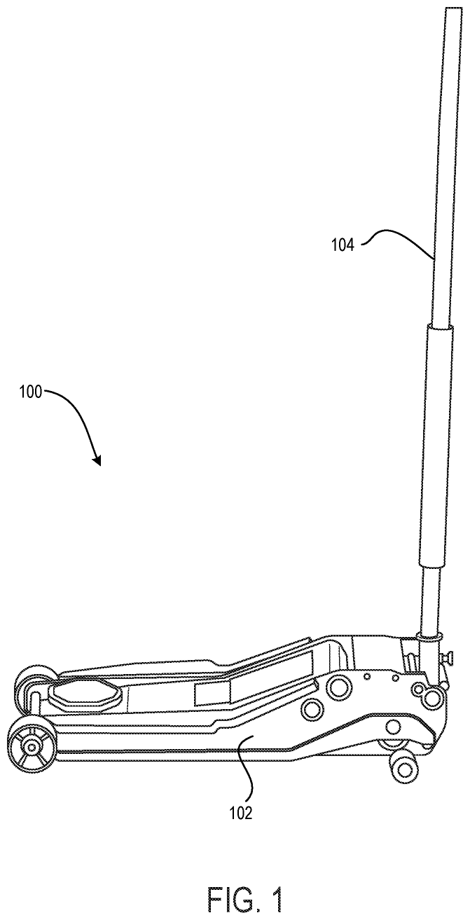

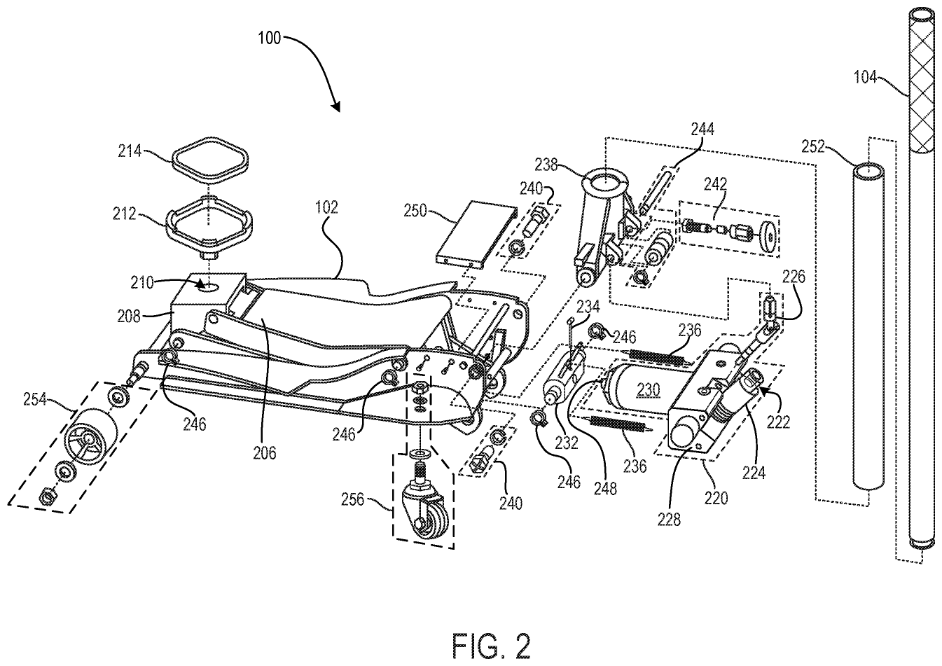

FIGS. 1 and 2 illustrate a jack 100 that includes a frame 102 and a jacking mechanism. The jacking mechanism includes a handle 104 operably coupled to a lifting arm 206 that is coupled to and movable relative to the frame 102 in response to motion of the handle 104. A saddle base 208 is coupled to the lifting arm 206 and moves with the lifting arm 206 in response to motion of the handle 104, allowing the saddle base 208 to raise a vehicle. The saddle base 208 may include an opening 210 that receives a stalk or other connector extending from an underside of a saddle 212 inserted into the opening 210. A pad 214 may be included on a vehicle-facing surface of the saddle 212 to help avoid marring or damaging the vehicle. The saddle 212 and pad 214 may be changeable to accommodate different types of lift points, depending upon the vehicle.

The hydraulics of the jack 100 are contained in a power unit 220. The power unit 220 includes a drive piston 222 slidably disposed in a fluid cylinder 224 to compress/pump fluid within the fluid cylinder 224, and a release valve mechanism 226. A valve block 228 of the power unit 220 is coupled to the frame 102, while a lift piston 248 that is slidable within a lift-piston assembly 230 of the power unit 220 is coupled to a trunnion block 232, which is coupled to the lift piston 248 (such as by a cotter pin 234).

The trunnion block 232 is coupled to the lifting arm 206. Pressure on the hydraulic fluid generated in the fluid cylinder 224 is transferred by the valve block 228 into the lift-piston assembly 230, and pushes against the lift piston 248 in the piston assembly 230. This generates a unidirectional force as the lift piston 248 pushes against the trunnion block 232. The trunnion block 232 transfers the pushing force from the lift piston 248 to the lifting arm 206, causing the saddle base 208 to rise.

A handle yoke 238 is pivotally coupled to the frame 102 by pivot bolts 240. The handle 104 is inserted into the handle yoke 238, and coupled by a retaining pin 242. A yolk pump roller assembly 244 is coupled to the handle yolk 238, and positioned so that when the handle 104 is operated or pumped, a roller of the roller assembly 244 compresses the drive piston 222, creating hydraulic pressure within the fluid cylinder 224. A spring (not illustrated) may be compressively disposed around the periphery of the drive piston 222, or enclosed within the fluid cylinder 224, to cause the drive piston 222 to rebound from the fluid cylinder 224 for the upstroke during pumping.

Depending on how the release valve mechanism 226 and the handle yoke 238 are configured, pushing the handle 104 forwardly or twisting the handle 104 pulls on the release valve mechanism 226, causing the release valve mechanism 226 to release the hydraulic pressure within the power unit 220. Springs 236 (or other bias means) may be disposed between the trunnion block 232 and the frame 102 to compress the lift piston 248 back into the piston assembly 230, creating reverse pressure on the hydraulic fluid in the piston assembly 230 so that the saddle base 208 descends when the release valve mechanism 226 is opened, even if there is no load on the jack 100.

Various components of the jack may be coupled in place, among other ways, using retaining rings 246. Once the jack 100 is assembled, a cover plate 250 may be coupled to the frame 102 to shield the internal components. An end of the handle 104 may be knurled or textured to provide a grip surface. As an additional grip surface, a handle pad 252 (e.g., foam) may be slid over the handle 104. The jack 100 may have wheels for ease-of mobility. FIG. 2 illustrates one-of-two front wheel assemblies 254, and one-of-two rear wheel assemblies 256, coupled to the frame 102. However, it should be appreciated that the wheels may be replaced by a singular roller.

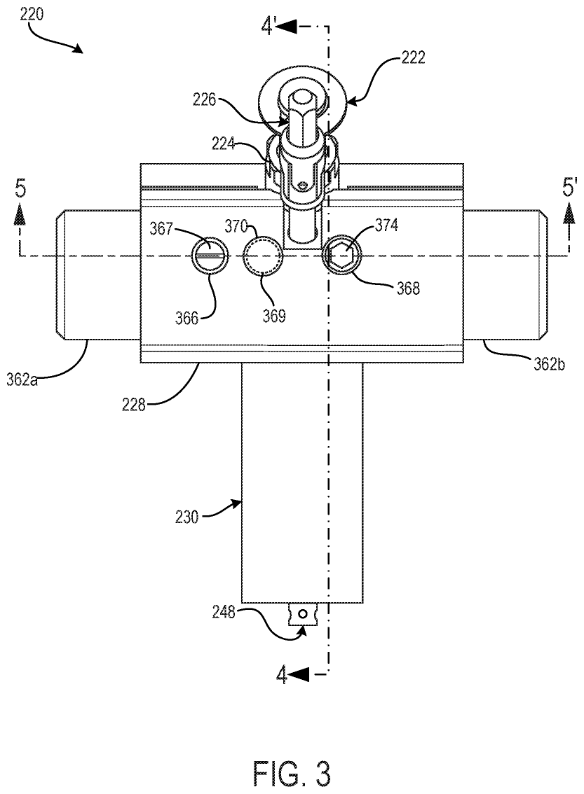

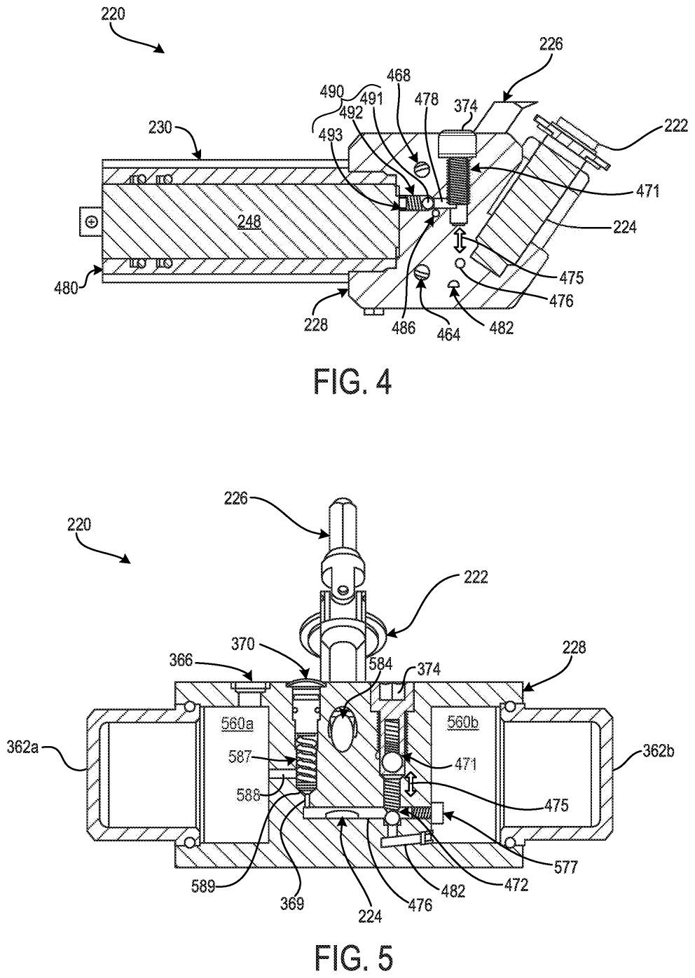

FIG. 3 is a top view of a power unit 220 according to an embodiment of the present invention. FIG. 4 is a cross-sectional cut-away view of the power unit 220 along the line 4-4′ in FIG. 3. FIG. 5 is a cross-sectional cut-away view of the power unit 220 along the line 5-5′ in FIG. 3.

The power unit 220 includes a fluid reservoir/tank, formed in part by a first reservoir cap 362a and a second reservoir cap 362b on opposite sides of the valve block 228. As shown in FIG. 5, the valve block 228 includes a first recess 560a and a second recess 560b on opposite sides of a long axis of the piston assembly 230. As shown in FIGS. 3 and 5, an open face of the first recess 560a is enclosed by the first reservoir cap 362a, and an open face of the second recess 560b is enclosed by the second reservoir cap 362b. Through-bores 464 and 468 (FIG. 4) through the valve block 228 fluidly couples the first recess 560a and the second recess 560b, providing a passage for the free-flow of fluid within the reservoir/tank formed by the combined recesses 560a/b, caps 362a/b, and through-bores 464 and 468.

A threaded through-bore 366 in the upper surface of the valve block 228 provides a port opening into the first recess 560a, via which hydraulic fluid may be added to the reservoir/tank. The threaded through-bore 366 is sealed by a threaded fill plug 367.

Another port in the upper surface of the valve block 228 is a first vertical bore hole 368 containing a vertically-oriented lift cylinder check valve 471 and a vertically-oriented vacuum-to-tank check valve 472. A threaded plug 374 over the lift cylinder check valve 471 seals off the external port at the top of the first vertical bore hole 368. The sealed first vertical bore hole 368 provides an internal vertical passage 475 for the flow of hydraulic fluid within the valve block 228.

Another port in the upper surface of the valve block 228 is a second vertical bore hole 369 containing a pressure relief valve 587. As illustrated in FIGS. 3 and 5, an external port of the second vertical bore hole 369 is covered with a tamper-resistant cap 370 to impede access to the pressure relief valve 587.

Referring to FIGS. 4 and 5, the lift cylinder check valve 471 comprises a spring and ball, with the ball located in the vertical passage 475 between a first horizontal passage 476 and a second horizontal passage 478. The first horizontal passage 476 connects the fluid cylinder 224 to the vertical passage 475 and to the pressure relief valve 587 in the second vertical bore hole 369. The first horizontal passage 476 may be formed as a bore hole in the valve block 228 that extends inward from the second recess 560b, to intersect the vertical passage 475, a base of the fluid cylinder 224, and a bottom of the second vertical bore hole 369. The port of the bore hole forming the first horizontal passage 476 that opens into the second recess 560b is sealed, such as by a threaded plug 577. The first horizontal passage 476 provides a fluid pathway between the fluid cylinder 224, and the lift cylinder check valve 471 and vacuum-to-tank check valve 472 disposed in the vertical passage 475 in one direction, and to the pressure relief valve 587 in the other direction. The second horizontal passage 478 is a bore hole in the valve block 228 that extends from the back of the piston assembly 230 to an upper-end of the vertical passage 475 and contains the horizontally-oriented SSCV 490. The SSCV 490 comprises a check ball 491, a bias member 492 (such as a spring), and a hollow check stop 493. The bias member 492 is compressed between the check ball 491 and the hollow check stop 493. The peripheral edge of the hollow check stop 493 may be externally threaded, coupled to threads in the sidewall of the second horizontal passage 478.

To lift a vehicle, movement of the handle 104 actuates the drive piston 222, compressing the fluid in the fluid cylinder 224. Pressure generated in the fluid cylinder 224 reaches the lift cylinder check valve 471 via the first horizontal passage 476, causing the lift cylinder check valve 471 to open so that hydraulic fluid flows to the second horizontal passage 478. The transferred pressure causes the SSCV 490 to open, allowing fluid to flow through an axial opening in the hollow check stop 493 and into the lift cylinder 480 of the piston assembly 230. The pressure at the back of the lift cylinder 480 pushes against the lift piston 248, with the resulting force being mechanically transferred to the lift arm 206 by the trunnion block 232.

When the pressure from the drive piston 222 and fluid cylinder 224 decreases, such as during an uptake of the handle 104 during pumping, the lift cylinder check valve 471 and the SSCV 490 close, to prevent the hydraulic fluid from flowing out of the lift cylinder 480 via the second horizontal passage 478. The SSCV 490 in fluid pathway out of the lift cylinder 480 helps prevent backflow into the lift cylinder check valve 471. During load bearing, where no input is applied to the drive piston 222, the SSCV acts as an additional means of leakdown protection, since fluid must now pass two check valves in a leak situation. In addition to limiting leakdown, the SSCV 490 acts as a secondary safety measure in the event that the lift cylinder check valve 471 opens or fails.

The bottom of the vertical passage 475 connects to a fluid intake passage 482. The fluid intake passage 482 comprises a bore hole in the valve block 228 extending from the bottom of the second recess 560b to the bottom of the vertical passage 475. The vacuum-to-tank check valve 472 comprises a bias member (such as a spring) and ball, located in the vertical passage 475 beneath the lift cylinder check valve 471. The ball of the vacuum-to-tank check valve 472 is positioned between the junction of the first horizontal passage 476 with the vertical passage 475, and the intake passage 482, to selectively open and close off the intake passage 482.

As the drive piston 222 rises after an uptake of the handle 104 during pumping, the drop in fluid pressure causes the vacuum-to-tank check valve 472 to open, with hydraulic fluid flowing from the reservoir/tank into the fluid cylinder 224. Specifically, hydraulic fluid flows from the reservoir/tank into the intake passage 482, through the open valve 472, and into the second horizontal passage 478, to be transferred into the fluid cylinder 224. When the fluid pressure in the fluid cylinder 224 increases, such as when the handle 104 actuates the drive piston 222, the vacuum-to-tank check valve 472 closes, preventing the flow of hydraulic fluid back into the reservoir/tank via the intake passage 482.

An external port of a diagonal though-bore 584 through the valve block 228 receives the release valve mechanism 226, with a portion of the release valve mechanism being within the diagonal through-bore 584, and another portion being external to the valve block 228. The end of the diagonal though-bore 584 opposite the external port opens into the back of the lift cylinder 480 of the piston assembly 230. Between the piston assembly 230 and the exterior port, the diagonal through-bore 584 intersects a third horizontal passage 486. The third horizontal passage 486 is formed as a bore through the valve block 228, and fluidly connects the diagonal though-bore 584 to one or both of the first and second recesses 560a, 560b. As illustrated, the third horizontal passage 486 fluidly connects the diagonal though-bore 584 to 560b.

During lifting, the release valve mechanism 226 closes off the third horizontal passage 486. To lower the saddle base 208, the release valve mechanism 226 is pulled outward, opening the third horizontal passage 486. This creates a pressure-release pathway from the piston assembly 230 through the diagonal though-bore 584 to the third horizontal passage 486, into the tank/reservoir. When open, hydraulic fluid evacuates the lift cylinder 480 via this pressure-release pathway.

As shown in FIG. 5, a fourth horizontal passage 588 through the valve block 228 connects the first recess 560a to the second vertical bore hole 369, intersecting the second vertical bore hole 369 above a member 589 of the pressure relief valve 587 that opens and closes the flow of fluid through the vertical bore hole 369 from the first horizontal passage 476. The member 589 may be, among other things, a disc or ball that is pressed against an aperture where the vertical bore hole 369 narrows via a bias member. When the pressure of the fluid in the vertical passage 475 exceeds a threshold limit, the pressure relief valve 587 opens, and the fourth horizontal passage 588 provides a pressure relief pathway back into the reservoir.

The bores, ports, and cavities within the power units 220 may be formed in the valve block 228 by machining the valve block. Integrated valves, such as valves 471, 472, 490 and 587 may then be assembled and adjusted within in the valve block 228.

From the foregoing, it can be seen that there has been described improved jack power units 220 which improves the safety of the jack 100 by providing a safeguard against the main check valve failing, while also providing improved leak resistance.

It will be appreciated that while the hydraulic power unit of the present invention is described as being used with a floor jack, that is exemplary and the hydraulic power unit of the present invention can be used with any type of hydraulically operated mechanism.

As used herein, the term “coupled” and its functional equivalents are not intended to necessarily be limited to direct, mechanical coupling of two or more components. Instead, the term “coupled” and its functional equivalents are intended to mean any direct or indirect mechanical, electrical, or chemical connection between two or more objects, features, work pieces, and/or environmental matter. “Coupled” is also intended to mean, in some examples, one object being integral with another object. As used herein, the term “a” or “one” may include one or more items unless specifically stated otherwise.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art.

1. A hydraulic power unit, the hydraulic power unit including a fluid reservoir, a valve block, a lift piston assembly coupled to the valve block, and a fluid cylinder coupled to the valve block, the hydraulic power unit comprising:
a first through-bore in the valve block extending from an external side of the valve block to the lift piston assembly;
a release passage in the valve block, fluidly connecting the first through-bore to the fluid reservoir;
a release valve disposed in the first through-bore and adapted to close the release passage during operation of the hydraulic power unit;
a vertical passage in the valve block, the vertical passage including first and second check valves;
a first horizontal passage in the valve block, fluidly connecting the fluid cylinder to the vertical passage, to communicate fluid between the fluid cylinder and the first and second check valves;
a second horizontal passage in the valve block, fluidly connecting the lift piston assembly to the vertical passage, wherein the first check valve is between the first and second horizontal passages; and
a secondary safety check valve in the second horizontal passage, the secondary safety check valve adapted to open in response to pressure received through the first check valve and transfer fluid from the fluid cylinder to the lift piston assembly.

2. The hydraulic power unit of claim 1, wherein the secondary safety check valve includes a ball and a bias member, and wherein movement of the ball in response to fluid pressure received from the first check valve opens the secondary safety check valve.

3. The hydraulic power unit of claim 2, wherein the secondary safety check valve further comprises a hollow check stop that compresses the bias member, wherein the hollow check stop includes an axial opening through which fluid passes into the lift piston assembly.

4. The hydraulic power unit of claim 1, further comprising a pressure relief valve selectively communicating fluid between the fluid cylinder and the fluid reservoir in response to fluid pressure exceeding a threshold limit.

5. The hydraulic power unit of claim 1, further comprising an intake passage in the valve block, fluidly connecting the fluid reservoir to the vertical passage, wherein the second check valve is between the first horizontal passage and the intake passage.

6. The hydraulic power unit of claim 1, further comprising
a first recess and a second recess defined in the valve block on opposite sides of a long axis of the lift piston assembly;
a first cap that encloses the first recess;
a second cap that encloses the second recess; and
a second through-bore defined in the valve block, connecting the first recess and the second recess.

7. A hydraulic power unit, comprising:
a valve block, the valve block including a fluid reservoir, and having a lift piston assembly extending from a first side and a fluid cylinder in a second side opposite the first side;
a first through-bore in the valve block extending from an external surface of the valve block to the lift piston assembly;
a release passage in the valve block, fluidly connecting the first through-bore to the fluid reservoir;
a release valve disposed in the first through-bore and adapted to close the release passage during operation of the hydraulic power unit;
a vertical passage in the valve block, the vertical passage including first and second check valves;
a first horizontal passage in the valve block, fluidly connecting the fluid cylinder to the vertical passage, to communicate fluid between the fluid cylinder and the first and second check valves;
a second horizontal passage in the valve block, fluidly connecting the lift piston assembly to the vertical passage, wherein the first check valve is between the first and second horizontal passages; and
a secondary safety check valve in the second horizontal passage, the secondary safety check valve adapted to open in response to pressure received through the first check valve and transfer fluid from the fluid cylinder to the lift piston assembly.

8. The hydraulic power unit of claim 7, wherein the secondary safety check valve includes a ball and a bias member, wherein movement of the ball in response to fluid pressure received from the first check valve opens the secondary safety check valve.

9. The hydraulic power unit of claim 8, wherein the secondary safety check valve further comprises a hollow check stop that compresses the bias member, wherein the hollow check stop includes an axial opening through which fluid passes into the lift piston assembly.

10. The hydraulic power unit of claim 7, further comprising a pressure relief valve selectively communicating fluid between the fluid cylinder and the fluid reservoir in response to fluid pressure exceeding a threshold limit.

11. The hydraulic power unit of claim 7, further comprising an intake passage in the valve block, fluidly connecting the fluid reservoir to the vertical passage, wherein the second check valve is between the first horizontal passage and the intake passage.

12. The hydraulic power unit of claim 7, further comprising
a first recess and a second recess defined in the valve block on opposite sides of a long axis of the lift piston assembly;
a first cap that encloses the first recess;
a second cap that encloses the second recess; and
a second through-bore defined in the valve block, connecting the first recess and the second recess.
